(19) United States
(12) Patent Application Publication
(10) Pub. No.: US 2016/0233750 A1
(43) Pub. Date: Aug. 11, 2016

(54) ROTOR CORE HEATING DEVICE AND ROTOR CORE SHRINK-FITTING METHOD

(71) Applicant: TOYOTA JIDOSHA KABUSHIKI KAISHA, Toyota-shi, Aichi-ken (JP)

(72) Inventors: Nobutaka NIBE, Toyota-shi (JP); Masayuki MATSUSHITA, Tokai-shi (JP); Koji YAMADA, Okazaki-shi (JP); Hiroaki URANO, Miyoshi-shi (JP); Kohei YOSHIDA, Toyota-shi (JP)

(73) Assignee: TOYOTA JIDOSHA KABUSHIKI KAISHA, Toyota-shi, Aichi-ken (JP)

(21) Appl. No.: 15/022,684

(22) PCT Filed: Sep. 15, 2014
(86) PCT No.: PCT/IB2014/002016

§ 371 Date: Mar. 17, 2016

(30) Foreign Application Priority Data
Sep. 17, 2013 (JP) 2013-192212
Jan. 14, 2014 (JP) 2014-004421
Feb. 4, 2014 (JP) 2014-019763

(51) Int. Cl. H02K 15/12; H02K 15/02; H02K 11/01; H02K 1/30

(52) U.S. Cl. CPC H02K 15/12; H02K 1/30; H02K 15/028; H02K 11/01

(57) ABSTRACT

A rotor core heating device (100) is configured to heat an inner peripheral side surface and an outer peripheral side surface of a rotor core (150) through induction heating. The rotor core has a hollow cylindrical shape. The rotor core heating device includes a first coil (110), a second coil (120) and a magnetic flux shielding jig (170). The first coil is disposed inside the rotor core and is configured to heat the inner peripheral side surface of the rotor core through induction heating. The second coil is disposed outside the rotor core and is configured to heat the outer peripheral side surface of the rotor core through induction heating. The magnetic flux shielding jig has a hollow cylindrical shape and is disposed opposite a first end surface of the rotor core with a gap provided between the first end surface and the magnetic flux shielding jig in an axial direction of the rotor core.

### BACKGROUND OF THE INVENTION

1. Field of the Invention

The present invention relates to a rotor core heating device and a rotor core shrink-fitting method.

2. Description of Related Art

A rotor core is a component of a motor. The motor is constituted by a shaft rotatably supported in a sealed case and having a rotor formed integrally at one end portion, a rotor core externally fitted on the shaft, and a stator fixed to the sealed case side to face the outer peripheral surface of the rotor with a predetermined gap therebetween.

In order to manufacture the motor, it is necessary to externally fit the rotor core onto the shaft. A shrink-fitting method is known as a method of externally fitting the rotor core. In shrink-fitting the rotor core onto the shaft, the rotor core is heated by a rotor core heating device, and the heated rotor core is cooled after being fitted onto the shaft.

For example, Japanese Patent Application Publication No. 07-022168 (JP 07-022168 A) and Japanese Patent Application Publication No. 2013-102622 (JP 2013-102622 A) disclose a rotor core heating device including a first heater that heats the inner peripheral side surface of a hollow cylindrical rotor core with a coil through induction heating, and a second heater that heats the outer peripheral side surface of the hollow cylindrical rotor core with a coil through induction heating.

The configuration of a rotor core heating device 500 according to the related art represented by JP 07-022168 A will be described with reference to FIG. 10A and FIG. 10B. In FIG. 10A and FIG. 10B, the configuration of the rotor core heating device 500 according to the related art is schematically illustrated as viewed in a cross section. In the following, description is made with reference to the axial direction indicated in FIG. 10A and FIG. 10B.

The rotor core heating device 500 is a device that heats a rotor core 550 through induction heating to shrink-fit the rotor core 550 onto a shaft (not illustrated). The rotor core heating device 500 includes an inner coil 510, an outer coil 520, and an induction heater (not illustrated).

The rotor core 550 is formed to have a cylindrical shape, and includes a hollow portion 560 formed to extend in the axial direction (see FIG. 10A). The rotor core 550 is constituted by stacking a plurality of steel plates.

The inner coil 510 is formed to have a spiral shape, and disposed on the inner peripheral side of the rotor core 550 (in the hollow portion 560). The inner coil 510 is disposed in the hollow portion 560 so as to extend spirally in the axial direction.

The outer coil 520 is formed to have a spiral shape, and disposed on the outer peripheral side of the rotor core 550. The outer coil 520 is disposed around the outer periphery of the rotor core 550 so as to extend spirally in the axial direction.

The induction heater applies an alternating current to the inner coil 510 and the outer coil 520 to generate magnetic force lines around the inner coil 510 and the outer coil 520.

In FIG. 10A, the length of the rotor core 550 in the axial direction is generally the same as the length of the inner coil 510 and the outer coil 520 in the axial direction. In FIG. 10B, meanwhile, the length of a rotor core 580 in the axial direction is shorter than the length of the inner coil 510 and the outer coil 520 in the axial direction.

The function of the rotor core heating device 500 according to the related art will be described with reference to FIG. 11. In FIG. 11, the function of the rotor core heating device 500 according to the related art is schematically illustrated as viewed in the cross-section. In FIG. 11, the length of the rotor core 580 in the axial direction is shorter than the length of the inner coil 510 and the outer coil 520 in the axial direction.

When magnetic force lines are generated around the inner coil 510 and the outer coil 520, the rotor core 580 disposed in the vicinity is affected by the magnetic force lines so that an eddy current flows in the rotor core 580. When a current flows in the rotor core 580, Joule heat is generated because of the electrical resistance of the rotor core 580 so that the rotor core 580 is self-heated.

In FIG. 11, as described above, the length of the rotor core 580 in the axial direction is shorter than the length of the inner coil 510 and the outer coil 520 in the axial direction. When the rotor core 580 is affected by the magnetic force lines, magnetic flux concentrates on the upper end surface of the rotor core 580 in the axial direction (location C in FIG. 11), which may cause a curl of a steel plate positioned at the upper end portion of the rotor core 580 due to abnormal heat generation.

For example, in the case where a steel plate is curled, the curled steel plate is thermally insulated from the other steel plates. Thus, the steel plate is further curled to reach a plastic region, which may deform the rotor core 580.

Therefore, in the related art, it is necessary to prepare dedicated rotor core heating devices corresponding to various lengths of a rotor core in the axial direction, which may increase the equipment cost. Thus, there is desired a general-purpose rotor core heating device capable of accommodating differences in length of a rotor core in the axial direction.

### SUMMARY OF THE INVENTION

The present invention provides a rotor core heating device and a rotor core shrink-fitting method capable of accommodating differences in length of a rotor core in the axial direction.

A rotor core heating device according to a first aspect of the present invention is configured to heat an inner peripheral side surface and an outer peripheral side surface of a rotor core through induction heating. The rotor core has a hollow cylindrical shape. The rotor core heating device includes a first coil, a second coil and a magnetic flux shielding jig. The first coil is disposed inside the rotor core and is configured to heat the inner peripheral side surface of the rotor core through induction heating. The second coil is disposed outside the rotor core and is configured to heat the outer peripheral side surface of the rotor core through induction heating. The magnetic flux shielding jig has a hollow cylindrical shape and is disposed opposite a first end surface of the rotor core with a gap provided between the first end surface and the magnetic flux shielding jig in an axial direction of the rotor core.

In the rotor core heating device according to the first aspect of the present invention, the magnetic flux shielding jig may include a first magnetic flux shielding jig that is opposite to the first end surface, and a second magnetic flux shielding jig that is opposite to a second end surface of the rotor core. The first magnetic flux shielding jig is disposed with the gap provided between the first end surface and the first magnetic flux shielding jig in the axial direction. The second magnetic flux shielding jig is disposed with a gap provided between the second end surface and the second magnetic flux shielding jig in the axial direction. Furthermore, both ends of the first coil in the axial direction may project from the rotor core.

With the rotor core heating device described above, differences in length of the rotor core in the axial direction can be accommodated.

In the rotor core heating device according to the first aspect of the present invention, a through portion that penetrates in the axial direction may be formed in the magnetic flux shielding jig.

With the rotor core heating device described above, the inside of the rotor core can be reliably heated.

In the rotor core heating device according to the first aspect of the present invention, the magnetic flux shielding jig may be made of copper.

A rotor core shrink-fitting method according to a second aspect of the present invention includes: heating a rotor core with the rotor core heating device according to the first aspect of the present invention to increase an inside diameter of the rotor core; and shrink-fitting the rotor core, an inside diameter of which has been increased, onto a shaft to fasten the rotor core to the shaft.

With the rotor core shrink-fitting method described above, differences in length of the rotor core in the axial direction can be accommodated.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view illustrating the configuration of a rotor core heating device according to a first embodiment of the present invention;

FIG. 2 is a schematic view illustrating the function of the rotor core heating device according to the first embodiment of the present invention;

FIG. 3 is a schematic view illustrating the function of the rotor core heating device according to the first embodiment of the present invention;

FIG. 4 is a schematic view illustrating the configuration of a rotor core heating device according to a second embodiment of the present invention;

FIG. 5 is a schematic view illustrating the function of the rotor core heating device according to the second embodiment of the present invention;

FIG. 6A is a schematic view illustrating the configuration of a magnetic flux shielding jig according to a third embodiment of the present invention;

FIG. 6B is a schematic view illustrating the configuration of a rotor core according to the third embodiment of the present invention;

FIG. 7 is a schematic view illustrating the configuration of a rotor core heating device according to the third embodiment of the present invention;

FIG. 8 is a schematic view illustrating the function of the rotor core heating device according to the third embodiment of the present invention;

FIG. 9A is a schematic view illustrating the configuration of another magnetic flux shielding jig according to a fourth embodiment of the present invention;

FIG. 9B is a schematic view illustrating the configuration of a rotor core according to the fourth embodiment of the present invention;

FIG. 10A is a schematic view illustrating the configuration of a rotor core heating device according to the related art;

FIG. 10B is a schematic view illustrating the configuration of a rotor core heating device according to the related art; and

FIG. 11 is a schematic view illustrating the function of the rotor core heating device according to the related art.

### DETAILED DESCRIPTION OF EMBODIMENTS

### First Embodiment

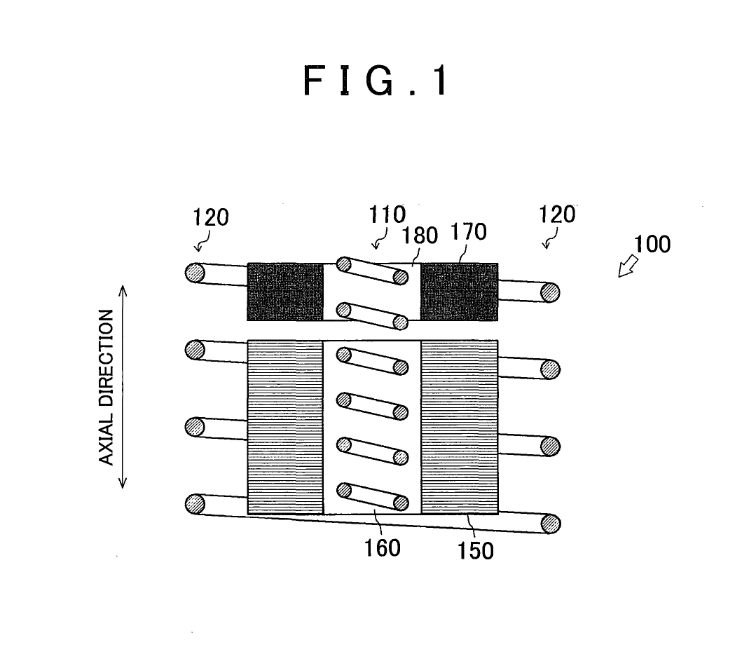

The configuration of a rotor core heating device 100 will be described with reference to FIG. 1. In FIG. 1, the configuration of the rotor core heating device 100 is schematically illustrated as viewed in the cross-section. In the following, description is made with reference to the axial direction indicated in FIG. 1.

The rotor core heating device 100 is a rotor core heating device according to a first embodiment of the present invention. The rotor core heating device 100 is a device that heats a rotor core 150 through induction heating to shrink-fit the rotor core 150 onto a shaft (not illustrated).

The rotor core 150 is a component of a motor (not illustrated). The motor is constituted by a shaft (not illustrated), the rotor core 150 externally fitted on the shaft, and a stator (not illustrated). The shaft is rotatably supported in a sealed case (not illustrated) and has a rotor formed integrally at one end portion. The stator is fixed to the sealed case side to face the outer peripheral surface of the rotor with a predetermined gap therebetween.

In order to manufacture the motor, it is necessary to externally fit the rotor core 150 onto the shaft. A shrink-fitting method is known as a method of externally fitting the rotor core 150. In shrink-fitting the rotor core 150 onto the shaft, the rotor core 150 is heated by the rotor core heating device 100, and the heated rotor core 150 is cooled after being fitted onto the shaft.

The rotor core heating device 100 includes an inner coil 110, an outer coil 120, an induction heater (not illustrated), and a magnetic flux shielding jig 170. The rotor core 150 is formed to have a cylindrical shape, and includes a hollow portion 160 formed to extend in the axial direction. The rotor core 150 is constituted by stacking a plurality of steel plates.

The inner coil 110 is formed to have a spiral shape, and disposed on the inner peripheral side of the rotor core 150 (in the hollow portion 160). The inner coil 110 is disposed in the hollow portion 160 so as to extend spirally in the axial direction.

The outer coil 120 is formed to have a spiral shape, and disposed on the outer peripheral side of the rotor core 150. The outer coil 120 is disposed around the outer periphery of the rotor core 150 so as to extend spirally in the axial direction.

The induction heater applies an alternating current to the inner coil 110 and the outer coil 120 to generate magnetic force lines around the inner coil 110 and the outer coil 120.

The magnetic flux shielding jig 170 is formed to have a cylindrical shape, and includes a hollow portion 180 formed to extend in the axial direction. The magnetic flux shielding jig 170 is made of copper. The cross-sectional shape of the magnetic flux shielding jig 170 as viewed in the axial direction is generally the same as the cross-sectional shape of the rotor core 150.

The magnetic flux shielding jig 170 is disposed above the rotor core 150 in the axial direction when the rotor core 150 is heated by the rotor core heating device 100. The magnetic flux shielding jig 170 is disposed with a gap provided between the rotor core 150 and the magnetic flux shielding jig 170 so as not to contact the rotor core 150. In the present embodiment, the sum of the length of the magnetic flux shielding jig 170 in the axial direction and the length of the rotor core 150 in the axial direction is generally the same as the length of the inner coil 110 and the outer coil 120 in the axial direction.

Preferably, the length of the inner coil 110 and the outer coil 120 in the axial direction is generally the same as the length of the longest rotor core, among rotor cores assumed to be heated, in the axial direction.

On the inner peripheral side of the axial end surface of the rotor core 150, magnetic flux tends to concentrate to generate abnormal heat. On the outer peripheral side of the axial end surface of the rotor core 150, on the other hand, magnetic flux is less likely to concentrate to generate abnormal heat than on the inner peripheral side. Therefore, although the outer shape of the magnetic flux shielding jig 170 is generally the same as the outer shape of the rotor core 150, the outside diameter of the magnetic flux shielding jig 170 may be larger than the outside diameter of the rotor core 150.

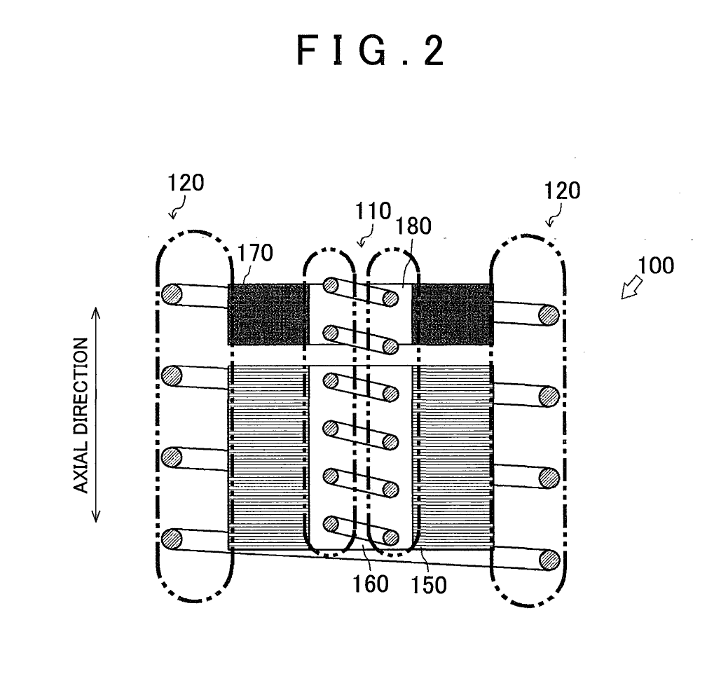

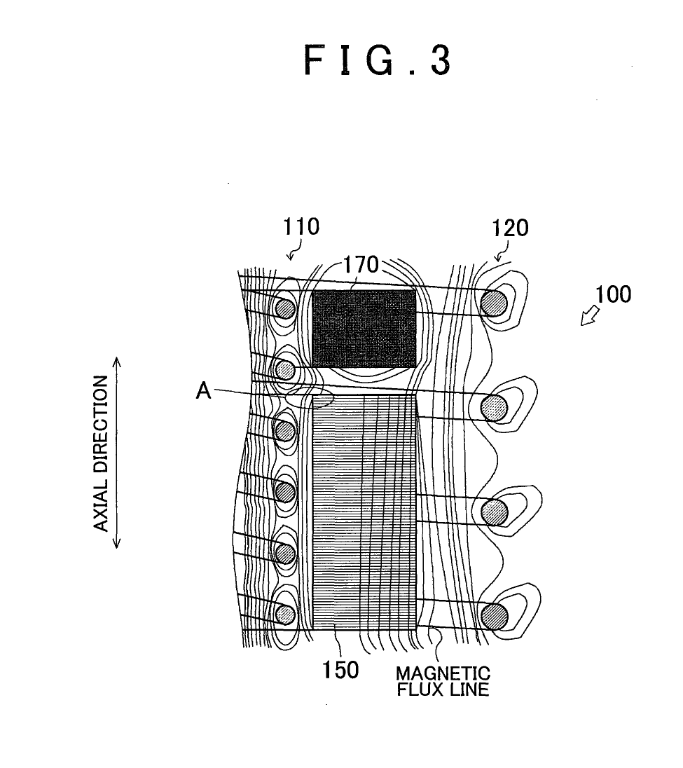

The function of the rotor core heating device 100 will be described with reference to FIG. 2 and FIG. 3. In FIG. 2 and FIG. 3, the function of the rotor core heating device 100 is schematically illustrated as viewed in the cross-section. In FIG. 2, magnetic flux lines are indicated by dash-double-dot lines.

When magnetic force lines are generated around the inner coil 110 and the outer coil 120, the rotor core 150 disposed in the vicinity is affected by the magnetic force lines so that an eddy current flows in the rotor core 150. When a current flows in the rotor core 150, Joule heat is generated because of the electrical resistance of the rotor core 150 so that the rotor core 150 is self-heated.

At this time, the magnetic flux shielding jig 170 is disposed above the rotor core 150 in the axial direction, and therefore concentration of magnetic flux on the upper end surface of the rotor core 150 in the axial direction is prevented. Magnetic flux is distributed as if the length of the rotor core 150 in the axial direction were generally the same as the length of the inner coil 110 and the outer coil 120 in the axial direction.

Therefore, magnetic flux does not concentrate on the upper end surface of the rotor core 150 in the axial direction (location A in FIG. 3), which prevents a curl of a steel plate from occurring because of abnormal heat generation.

The effect of the rotor core heating device 100 will be described. According to the rotor core heating device 100, differences in length of the rotor core 150 in the axial direction can be accommodated by preparing a plurality of types of the magnetic flux shielding jig 170 corresponding to various lengths of the rotor core 150 in the axial direction based on differences in lengths of the rotor core 150 in the axial direction.

That is, differences in length of the rotor core 150 in the axial direction can be accommodated by preparing a plurality of types of the magnetic flux shielding jig 170 such that the sum of the length of a magnetic flux shielding jig 170 in the axial direction and the length of the rotor core 150 in the axial direction is generally the same as the length of the inner coil 110 and the outer coil 120 in the axial direction for each set of the inner coil 110 and the outer coil 120.

In the present embodiment, the magnetic flux shielding jig 170 is made of cupper. However, the present invention is not limited thereto. For example, if the magnetic flux shielding jig 170 is made of any magnetic material such as iron, the same function and effect as those of the first embodiment can be obtained.

In the present embodiment, the sum of the length of the magnetic flux shielding jig 170 in the axial direction and the length of the rotor core 150 in the axial direction is generally the same as the length of the inner coil 110 and the outer coil 120 in the axial direction. However, the present invention is not limited thereto.

The sum of the length of the magnetic flux shielding jig 170 in the axial direction and the length of the rotor core 150 in the axial direction may be longer than the length of the inner coil 110 and the outer coil 120 in the axial direction. Alternatively, the sum of the length of the magnetic flux shielding jig 170 in the axial direction and the length of the rotor core 150 in the axial direction may be shorter than the length of the inner coil 110 and the outer coil 120 in the axial direction. In either case, the same function and effect as those of the first embodiment can be obtained.

### Second Embodiment

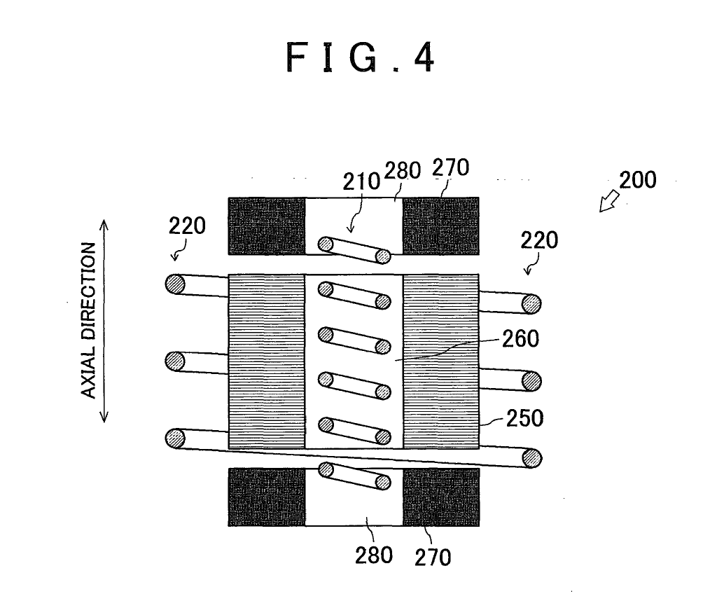

The configuration of a rotor core heating device 200 will be described with reference to FIG. 4. In FIG. 4, the configuration of the rotor core heating device 200 is schematically illustrated as viewed in the cross-section. In the following, description is made with reference to the axial direction indicated in FIG. 4.

The rotor core heating device 200 is a rotor core heating device according to a second embodiment of the present invention. The rotor core heating device 200 is a device that heats a rotor core 250 through induction heating to shrink-fit the rotor core 250 onto a shaft (not illustrated).

The rotor core 250 is a component of a motor (not illustrated). The motor is constituted by a shaft (not illustrated), the rotor core 250 externally fitted on the shaft, and a stator (not illustrated). The shaft is rotatably supported in a sealed case (not illustrated) and has a rotor formed integrally at one end portion. The stator is fixed to the sealed case side to face the outer peripheral surface of the rotor with a predetermined gap therebetween

In order to manufacture the motor, it is necessary to externally fit the rotor core 250 onto the shaft. A shrink-fitting method is known as a method of externally fitting the rotor core 250. In shrink-fitting the rotor core 250 onto the shaft, the rotor core 250 is heated by the rotor core heating device 200, and the heated rotor core 250 is cooled after being fitted onto the shaft.

The rotor core heating device 200 includes an inner coil 210, an outer coil 220, an induction heater (not illustrated), and magnetic flux shielding jigs 270. The rotor core 250 is formed to have a cylindrical shape, and includes a hollow portion 260 formed to extend in the axial direction. The rotor core 250 is constituted by stacking a plurality of steel plates.

The inner coil 210 is formed to have a spiral shape, and disposed on the inner peripheral side of the rotor core 250 (in the hollow portion 260). The inner coil 210 is disposed in the hollow portion 260 so as to extend spirally in the axial direction. The length of the inner coil 210 in the axial direction is longer than the length of the rotor core 250 in the axial direction.

The inner coil 210 is disposed with respect to the rotor core 250 such that both the upper and lower ends of the inner coil 210 in the axial direction project from the rotor core 250. More particularly, the inner coil 210 is preferably disposed at a position at which the middle portion of the inner coil 210 and the middle portion of the rotor core 250, generally coincide with each other in the axial direction.

The outer coil 220 is formed to have a spiral shape, and disposed on the outer peripheral side of the rotor core 250. The outer coil 220 is disposed around the outer periphery of the rotor core 250 so as to extend spirally in the axial direction.

The induction heater applies an alternating current to the inner coil 210 and the outer coil 220 to generate magnetic force lines around the inner coil 210 and the outer coil 220.

The magnetic flux shielding jigs 270 are formed to have a cylindrical shape, and include a hollow portion 280 formed to extend in the axial direction. The magnetic flux shielding jigs 270 are made of copper. The cross-sectional shape of the magnetic flux shielding jigs 270 as viewed in the axial direction is generally the same as the cross-sectional shape of the rotor core 250.

The magnetic flux shielding jigs 270 are disposed above and below the rotor core 250 in the axial direction when the rotor core 250 is heated by the rotor core heating device 200. The magnetic flux shielding jigs 270 are disposed with a gap provided between the rotor core 250 and each of the magnetic flux shielding jigs 270 so as not to contact the rotor core 250.

On the inner peripheral side of the axial end surface of the rotor core 250, magnetic flux tends to concentrate to generate abnormal heat. On the outer peripheral side of the axial end surface of the rotor core 250, on the other hand, magnetic flux is less likely to concentrate to generate abnormal heat than on the inner peripheral side. Therefore, although the outer shape of the magnetic flux shielding jigs 270 is generally the same as the outer shape of the rotor core 250, the outside diameter of the magnetic flux shielding jigs 270 may be larger than the outside diameter of the rotor core 250.

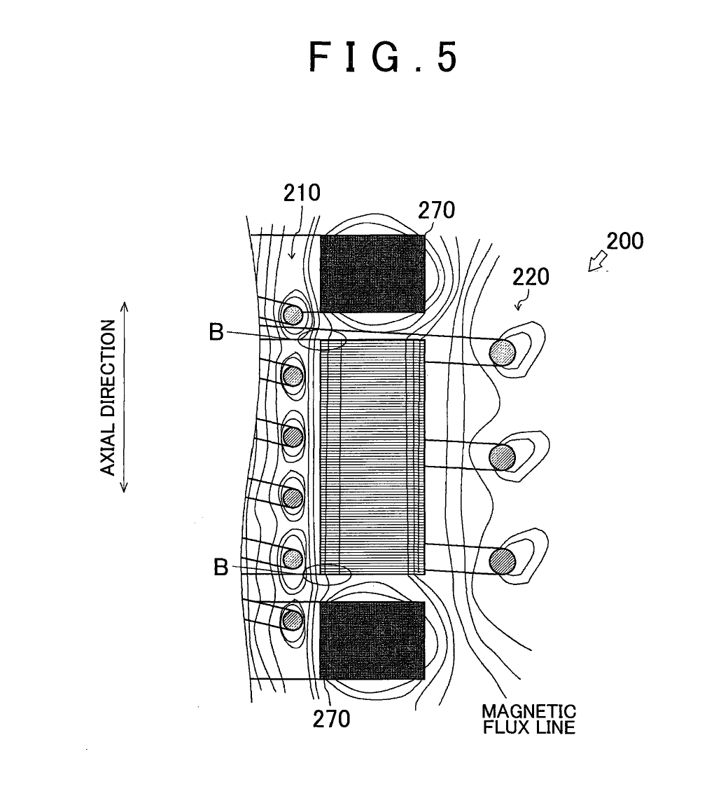

The function of the rotor core heating device 200 will be described with reference to FIG. 5. In FIG. 5, the function of the rotor core heating device 200 is schematically illustrated as viewed in the cross-section.

When magnetic force lines are generated around the inner coil 210 and the outer coil 220, the rotor core 250 disposed in the vicinity is affected by the magnetic force lines so that an eddy current flows in the rotor core 250. When a current flows in the rotor core 250, Joule heat is generated because of the electrical resistance of the rotor core 250 so that the rotor core 250 is self-heated.

At this time, the magnetic flux shielding jigs 270 are disposed above and below the rotor core 250 in the axial direction, and therefore concentration of magnetic flux on the upper end surface and the lower end surface of the rotor core 250 in the axial direction is prevented. Magnetic flux is distributed as if the length of the rotor core 250 in the axial direction were generally the same as the sum of the respective lengths, in the axial direction, of the magnetic flux shielding jig 270 disposed on the upper side and the magnetic flux shielding jig 270 disposed on the lower side.

Therefore, magnetic flux does not concentrate on the upper end surface or the lower end surface of the rotor core 250 in the axial direction (location B in FIG. 5), which prevents a curl of a steel plate from occurring because of abnormal heat generation. In addition, the magnetic flux shielding jigs 270 are disposed above and below the rotor core 250 in the axial direction, and thus the rotor core 250 generates a magnetic field that is uniform in the axial direction. Consequently, the rotor core 250 is heated uniformly in the axial direction so that the inside diameter of the rotor core 250 is increased uniformly.

The effect of the rotor core heating device 200 will be described. According to the rotor core heating device 200, differences in length of the rotor core 250 in the axial direction can be accommodated. That is, differences in length of the rotor core 250 in the axial direction can be accommodated by disposing the magnetic flux shielding jigs 270 above and below the rotor core 250 if the rotor core 250 has a length, in the axial direction, that is shorter than the length of the inner coil 210 in the axial direction, for each set of the inner coil 210 and the outer coil 220.

In the rotor core heating device 200 in which the magnetic flux shielding jigs 270 are disposed above and below the rotor core 250 in the axial direction, in addition, a magnetic field that is uniform in the axial direction of the rotor core 250 is generated in contrast to the rotor core heating device 100 according to the first embodiment. Consequently, the rotor core 250 can be heated uniformly in the axial direction so that the inside diameter of the rotor core 250 can be increased uniformly.

In the present embodiment, the magnetic flux shielding jigs 270 are made of cupper. However, the present invention is not limited thereto. For example, if the magnetic flux shielding jigs are made of any magnetic material such as iron, the same function and effect as those of the second embodiment can be obtained.

A rotor core shrink-fitting method according to an embodiment of the present invention will be described. The rotor core shrink-fitting method according to the embodiment includes: heating the rotor core 150 or the rotor core 250 with the rotor core heating device 100 or the rotor core heating device 200 to increase the inside diameter of the rotor core 150 or the rotor core 250; and shrink-fitting the rotor core 150 or the rotor core 250, the inside diameter of which has been increased, onto a shaft to fasten the rotor core 150 or the rotor core 250 to the shaft.

### Third Embodiment

If the magnetic flux shielding jig 170 is disposed above the rotor core 150 in the axial direction in the rotor core heating device 100′ according to the first embodiment, magnetic flux that passes through the inside of the rotor core 150 may be blocked so that the inside of the rotor core 150 may be heated to a reduced degree.

That is, the rotor core heating device 100 according to the first embodiment has room for improvement of the working efficiency in reliably heating the inside of the rotor core 150 and shortening the heating time.

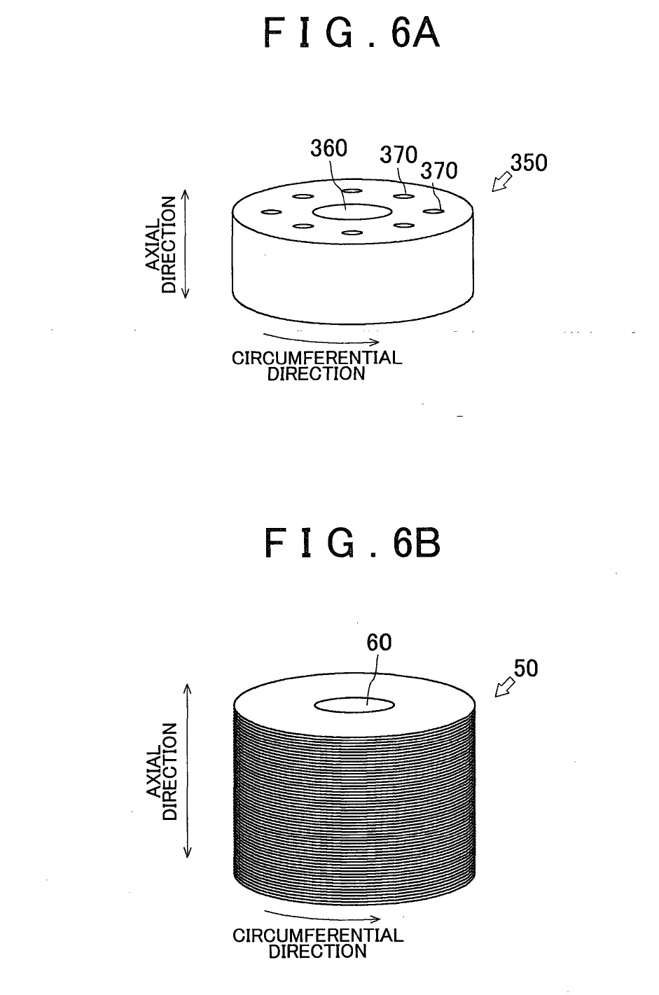

The configuration of a rotor core 50 and a magnetic flux shielding jig 350 according to a third embodiment of the present invention will be described with reference to FIG. 6A and FIG. 6B. FIG. 6A is a perspective view schematically illustrating the configuration of the magnetic flux shielding jig 350. FIG. 6B is a perspective view schematically illustrating the configuration of the rotor core 50. In the following, description is made with reference to the axial direction and the circumferential direction indicated in FIG. 6A and FIG. 6B.

The rotor core 50 is a rotor core according to the third embodiment of the present invention. The rotor core 50 is to be heated by a rotor core heating device 300 to be discussed later.

The rotor core 50 is a component of a motor (not illustrated). The motor is constituted by a shaft (not illustrated), the rotor core 50 externally fitted on the shaft, and a stator (not illustrated). The shaft is rotatably supported in a sealed case (not illustrated) and has a rotor formed integrally at one end portion. The stator is fixed to the sealed case side to face the outer peripheral surface of the rotor with a predetermined gap therebetween.

In order to manufacture the motor, it is necessary to externally fit the rotor core 50 onto the shaft. A shrink-fitting method is known as a method of externally fitting the rotor core 50. In shrink-fitting the rotor core 50 onto the shaft, the rotor core 50 is heated by the rotor core heating device 300, and the heated rotor core 50 is cooled after being fitted onto the shaft.

The rotor core 50 is constituted by stacking a plurality of steel plates, and formed to have a hollow cylindrical shape. The rotor core 50 has a hollow portion 60 formed to penetrate in the axial direction.

The hollow portion 60 is a hole into which a shaft is inserted when the rotor core 50 is assembled into the motor. The hollow portion 60 is formed in the center portion of the rotor core 50 to have a circular shape as viewed in a plan.

The magnetic flux shielding jig 350 is formed to have a hollow cylindrical shape, and disposed above the rotor core 50 in the axial direction when the rotor core 50 is heated by the rotor core heating device 300. The magnetic flux shielding jig 350 is constituted to have a generally cylindrical shape. The magnetic flux shielding jig 350 has a hollow portion 360 that penetrate in the axial direction, and a plurality of through holes 370 that serve as a through portion.

The hollow portion 360 is formed in the center portion of the magnetic flux shielding jig 350 to have a circular shape as viewed in the plan. The hollow portion 360 is formed to have generally the same diameter as the hollow portion 60 of the rotor core 50, and formed generally at the same position as the hollow portion 60 of the rotor core 50 as viewed in the plan when the magnetic flux shielding jig 350 is disposed above the rotor core 50 in the axial direction and generally coaxially with the rotor core 50.

The plurality of through holes 370 are disposed at equal intervals in the circumferential direction generally at the edge portion of the magnetic flux shielding jig 350 on the outer peripheral side as viewed in the plan.

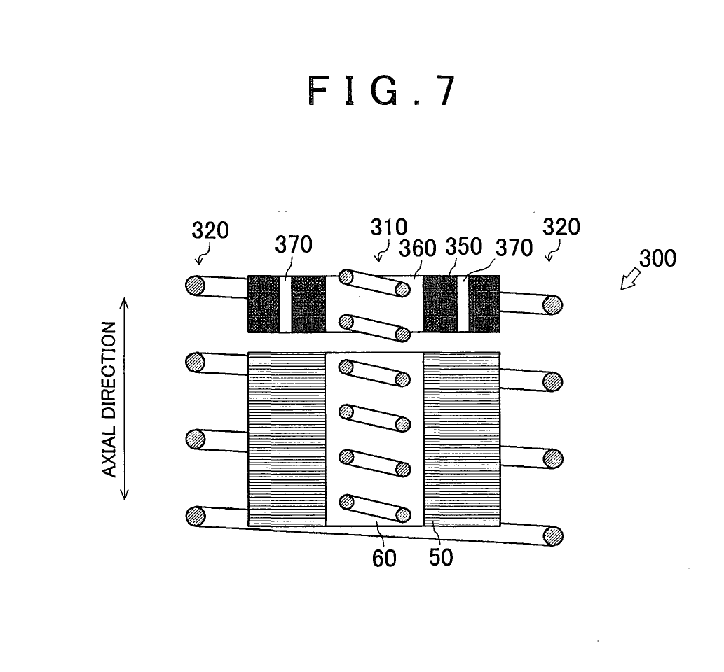

The configuration of a rotor core heating device 300 will be described with reference to FIG. 7. In FIG. 7, the configuration of the rotor core heating device 300 is schematically illustrated as viewed in the cross-section. In the following, description is made with reference to the axial direction indicated in FIG. 7.

The rotor core heating device 300 is a rotor core heating device according to an embodiment of the present invention. The rotor core heating device 300 is a device that heats a rotor core 50 through induction heating to shrink-fit the rotor core 50 onto a shaft (not illustrated).

The rotor core heating device 300 includes an inner coil 310, an outer coil 320, an induction heater (not illustrated), and the magnetic flux shielding jig 350 discussed above.

The inner coil 310 is formed to have a spiral shape, and disposed on the inner peripheral side of the rotor core 50 (in the hollow portion 60). The inner coil 310 is disposed in the hollow portion 60 so as to extend spirally in the axial direction.

The outer coil 320 is formed to have a spiral shape, and disposed on the outer peripheral side of the rotor core 50. The outer coil 320 is disposed around the outer periphery of the rotor core 50 so as to extend spirally in the axial direction.

The induction heater applies an alternating current to the inner coil 310 and the outer coil 320 to generate magnetic force lines around the inner coil 310 and the outer coil 320.

The magnetic flux shielding jig 350 is disposed above the rotor core 50 in the axial direction when the rotor core 50 is heated by the rotor core heating device 300.

The magnetic flux shielding jig 350 is disposed with a gap provided between the rotor core 50 and the magnetic flux shielding jig 350 so as not to contact the rotor core 50. In the present embodiment, the sum of the length of the magnetic flux shielding jig 350 in the axial direction and the length of the rotor core 50 in the axial direction is generally the same as the length of the inner coil 310 and the outer coil 320 in the axial direction.

In the present embodiment, the magnetic flux shielding jig 350 is disposed above the rotor core 50 in the axial direction. However, the present invention is not limited thereto. For example, the magnetic flux shielding jig 350 may be disposed below the rotor core 50 in the axial direction.

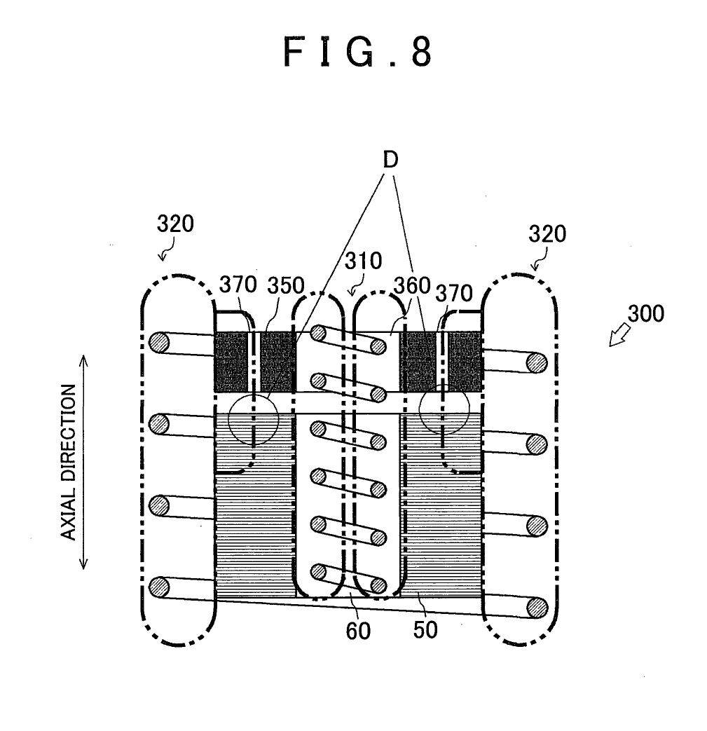

The function of the rotor core heating device 300 will be described with reference to FIG. 8. In FIG. 8, the function of the rotor core heating device 300 is schematically illustrated as viewed in the cross-section. In FIG. 8, in addition, magnetic flux lines are indicated by dash-double-dot lines.

When magnetic flux is generated around the inner coil 310 and the outer coil 320, the rotor core 50 disposed in the vicinity is affected by the magnetic flux so that an eddy current flows in the rotor core 50. When a current flows in the rotor core 50, Joule heat is generated because of the electrical resistance of the rotor core 50 so that the rotor core 50 is self-heated.

It is assumed that magnetic flux is generated from at least one of the inner coil 310 and the outer coil 320.

In the rotor core heating device 300, the plurality of through holes 370 are formed in the magnetic flux shielding jig 350 as viewed in the plan. Therefore, magnetic flux is not blocked by the magnetic flux shielding jig 350, but passes through the through holes 370 of the magnetic flux shielding jig 350. Therefore, the inside of the rotor core 50 is sufficiently heated.

The effect of the rotor core heating device 300 will be described. According to the rotor core heating device 300, the inside of the rotor core 50 can be reliably heated. That is, the inside of the rotor core 50 is sufficiently heated by forming the through holes 370 in the magnetic flux shielding jig 350 and allowing magnetic flux to pass through the through holes 370.

### Fourth Embodiment

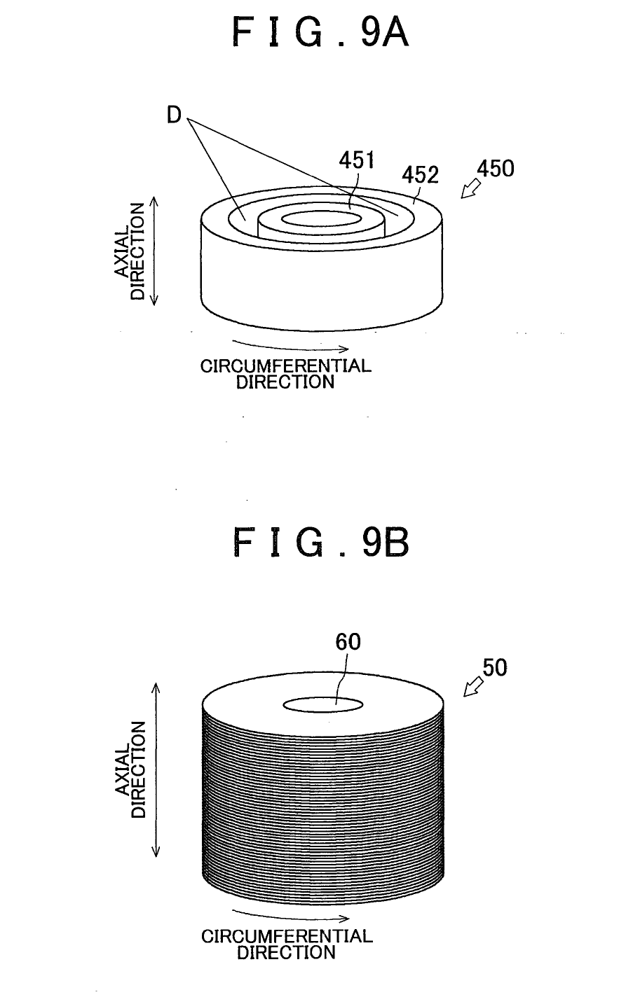

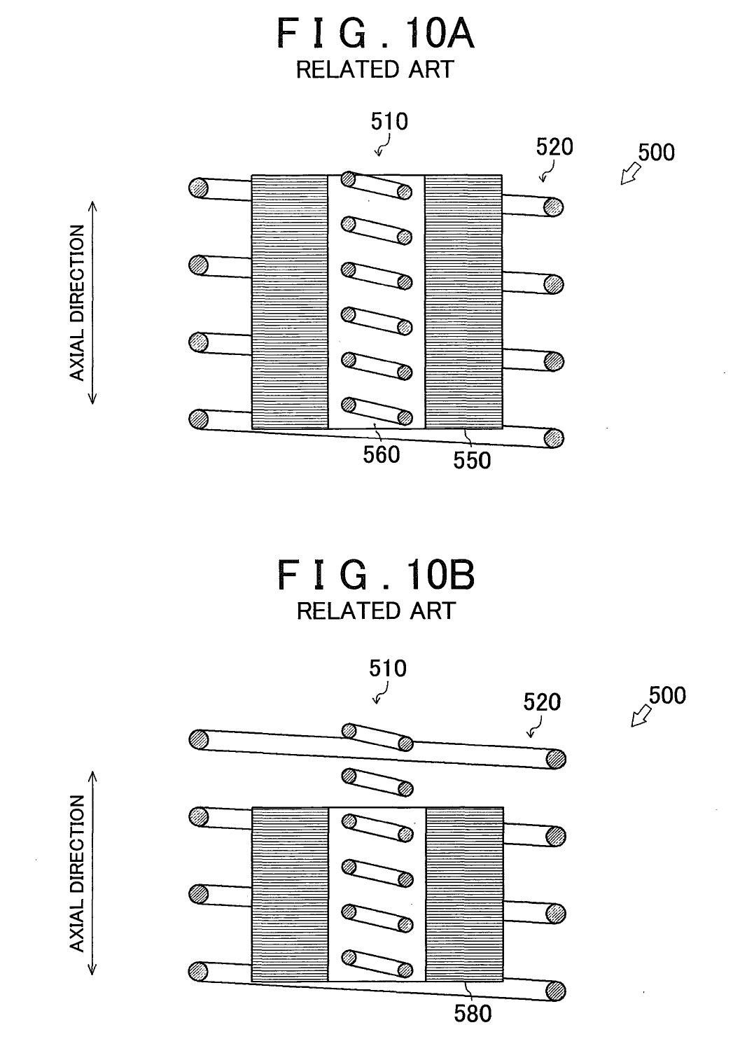

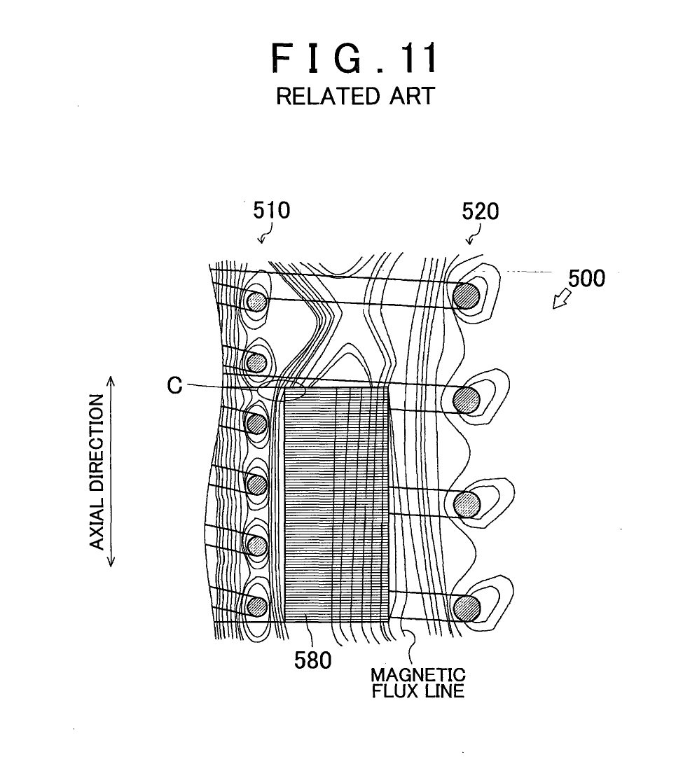

The configuration of a rotor core 50 and a magnetic flux shielding jig 450 according to a fourth embodiment of the present invention will be described with reference to FIG. 9A and FIG. 9B. FIG. 9A is a perspective view schematically illustrating the configuration of the magnetic flux shielding jig 450. FIG. 9B is a perspective view schematically illustrating the configuration of the rotor core 50.

The rotor core 50 has the configuration discussed above, and will not be described in detail.

The magnetic flux shielding jig 450 is constituted by an inner peripheral portion 451 and an outer peripheral portion 452. The inner peripheral portion 451 is formed to have a hollow cylindrical shape. The outer peripheral portion 452 is also formed to have a hollow cylindrical shape. The inner peripheral portion 451 is disposed inside the outer peripheral portion 452. The inner peripheral portion 451 and the outer peripheral portion 452 are disposed with a predetermined gap D, which serves as a through portion, provided therebetween.

A rotor core heating device, having the magnetic flux shielding jig 450 configured in this way achieves the same function and effect as those of the rotor core heating device 300.

The technical features of the first to fourth embodiments described above may be used in appropriate combination.

1. A rotor core heating device configured to heat an inner peripheral side surface and an outer peripheral side surface of a rotor core through induction heating, the rotor core having a hollow cylindrical shape, the rotor core heating device comprising:
a first coil disposed inside the rotor core and configured to heat the inner peripheral side surface of the rotor core through induction heating;
a second coil disposed outside the rotor core and configured to heat the outer peripheral side surface of the rotor core through induction heating; and
a magnetic flux shielding jig having a hollow cylindrical shape and disposed opposite a first end surface of the rotor core with a gap provided between the first end surface and the magnetic flux shielding jig in an axial direction of the rotor core.

2. The rotor core heating device according to claim 1, wherein:
the magnetic flux shielding jig includes a first magnetic flux shielding jig that is opposite to the first end surface, and a second magnetic flux shielding jig that is opposite to a second end surface of the rotor core;
the first magnetic flux shielding jig is disposed with the gap provided between the first end surface and the first magnetic flux shielding jig in the axial direction;
the second magnetic flux shielding jig is disposed with a gap provided between the second end surface and the second magnetic flux shielding jig in the axial direction; and
both ends of the first coil in the axial direction project from the rotor core.

3. The rotor core heating device according to claim 1, wherein
a through portion that penetrates in the axial direction is formed in the magnetic flux shielding jig.

4. The rotor core heating device according to claim 3, wherein
the through portion is formed of a plurality of through holes.

5. The rotor core heating device according to claim 3, wherein:
the magnetic flux shielding jig is constituted by an inner peripheral portion and an outer peripheral portion;
the inner peripheral portion has a hollow cylindrical shape;
the outer peripheral portion has a hollow cylindrical shape;
the inner peripheral portion is disposed inside the outer peripheral portion; and
the through portion is a gap formed between the inner peripheral portion and the outer peripheral portion.

6. The rotor core heating device according to claim 1, wherein
the magnetic flux shielding jig is made of copper.

7. A rotor core shrink-fitting method comprising:
heating a rotor core with the rotor core heating device according to claim 1 to increase an inside diameter of the rotor core; and
shrink-fitting the rotor core, an inside diameter of which has been increased, onto a shaft to fasten the rotor core to the shaft.
